(19) United States
(12) Patent Application Publication
(10) Pub. No.: US 2004/0046070 A1
(43) Pub. Date: Mar. 11, 2004

(54) Nozzle assembly for an air pump

(76) Inventor: Hsi-Kung Yang, Shu Lin Chen (TW)

Correspondence Address: DELLETT AND WALTERS, 310 S.W. FOURTH AVENUE, SUITE 1101, PORTLAND, OR, 97204, US

(21) Appl. No.: 10/235,905

(22) Filed: Sep. 4, 2002

(51) Int. Cl. B05B 1/00

(52) U.S. Cl. 239/600

(57) ABSTRACT

A nozzle assembly for an air pump has an inner threading formed on an inner periphery defining the outlet of the barrel so as to adapt to correspond to an outer threading of a needle. An annular recess is defined in an outer periphery of the seal so that the seal is able to be secured by the flange after the seal is inserted into the outlet of the barrel.

### BACKGROUND OF THE INVENTION

1. Field of the Invention

The present invention relates to a nozzle assembly for an air pump, and more particularly to a nozzle assembly which is adapted to directly connect to an air transmission device so as to decrease the labor in assembly and cost in manufacturing elements.

2. Description of Related Art

A conventional air pump is shown in FIGS. 3 and 4, wherein the air pump includes a barrel (50), a seal (60), a metal connector (70) and an air transmission device (80). The air transmission device (80) in this example is a needle.

The barrel (50) has a nozzle (51) and a flange (52) formed on an inner face of the barrel (50).

The seal (60) has an air path (61) defined to communicate with an inside of the barrel (50) and a neck (62) corresponding to the flange (52) of the barrel (50).

The connector (70) is a disk-like connector and has a through hole (not numbered) defined through the connector (70) and an inner threading (71) formed on an inner periphery defining the through hole.

The needle (80) has an outer threading (81) formed to correspond to the inner threading (71) of the connector (70).

When this conventional air pump is in assembly, the seal (60) is inserted into the nozzle (51) and then the seal (60) is stopped from further advancement into the barrel (50) by the combination of the flange (52) and the neck (62). Thereafter, the connector (70) is force fitted into the nozzle (51) to sandwich the seal (60) with the barrel (50). Then, the needle (80) is screwed into the inner threading of the connector (70) to complete the assembly.

While viewing the assembly, it is noted that the function of the connector (70) is to sandwich the seal (60) with the barrel (50) and to connect to the needle (80). However, because the assembly between the connector (70) and the barrel (50) is by force fitting, the manufacturer will need extra tools to accomplish the projected objective. Accordingly, labor cost rises and manufacturing cost for this connector also rises.

To overcome the shortcomings, the present invention tends to provide an improved nozzle assembly of an air pump to mitigate and obviate the aforementioned problems.

### SUMMARY OF THE INVENTION

The primary objective of the present invention is to provide an improved nozzle assembly of an air pump. The nozzle assembly enables the reduce of cost in manufacture and facilitates the assembly of the air pump.

In order to accomplish the foregoing objective, the nozzle assembly of the present invention has an inner threading formed on an outlet of a barrel to adapt to the outer threading of the needle, a flange formed on an inner periphery of the barrel and an annular recess defined in a seal to correspond to the flange of the barrel. With the foregoing arrangement, the cost of manufacture is reduced and the assembly is facilitated.

Other objects, advantages and novel features of the invention will become more apparent from the following detailed description when taken in conjunction with the accompanying drawings.

### BRIEF DESCRIPTION OF THE DRAWINGS

FIG. 1 is a plan view in cross section of the nozzle assembly of the present invention;

FIG. 2 is a plan view in cross section of the nozzle assembly in assembly in an air pump;

FIG. 3 is a plan view in cross section of a conventional nozzle assembly of the air pump; and

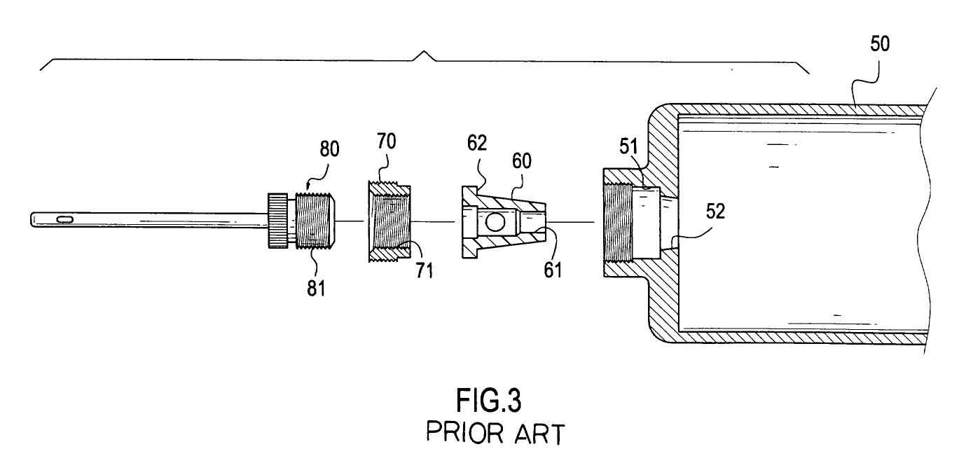

FIG. 4 is a plan view in cross section of the conventional nozzle assembly in assembly in the air pump.

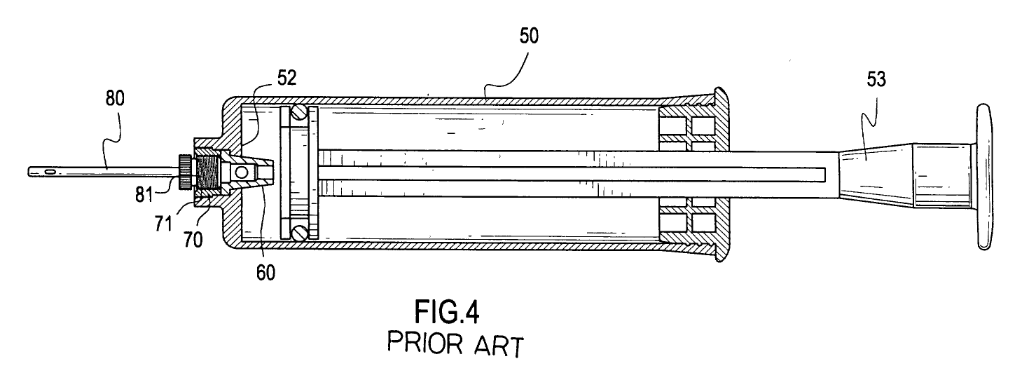

### DETAILED DESCRIPTION OF THE PREFERRED EMBODIMENT

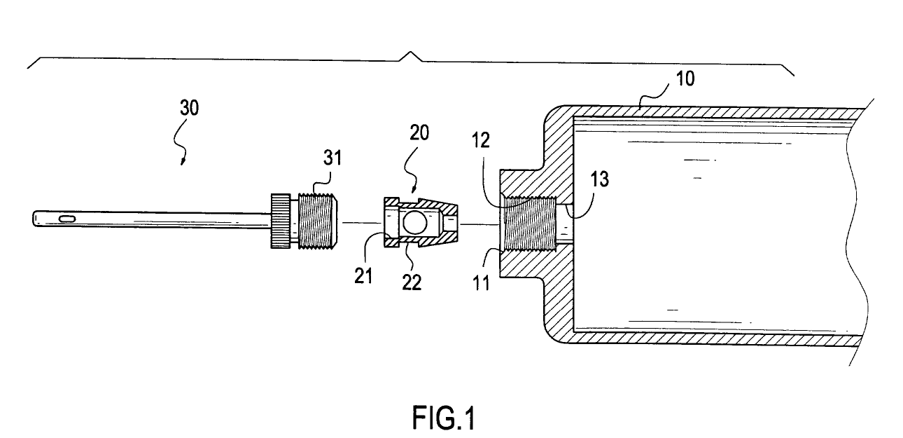

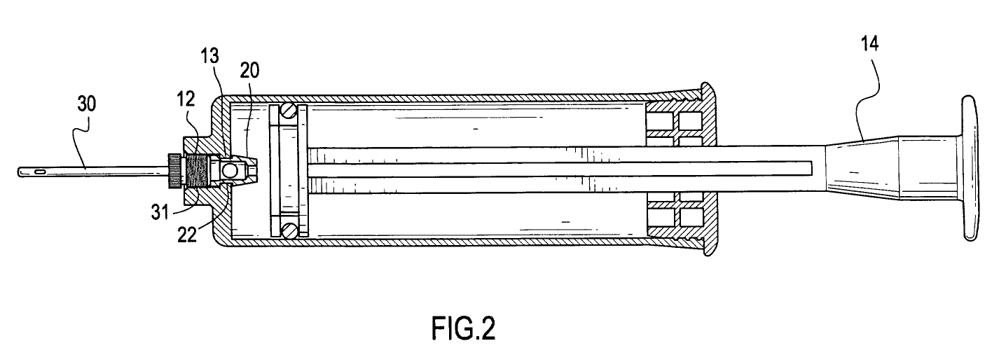

With reference to FIGS. 1 and 2, the nozzle assembly in accordance with the present invention includes an outlet (11) defined in a barrel (10), an inner threading (12) formed on an inner periphery defining the outlet (11) and a flange (13) formed in the barrel (10).

A seal (20) inserted into the outlet (11) of the barrel (10) has a channel (21) defined to communicate with an inside of the barrel (10) and an annular recess (22) defined to correspond to the flange (13) of the barrel (10).

When the nozzle assembly of the present invention is in assembly, the seal (20) is inserted into the outlet (11) of the barrel (10) and because of the corresponding relationship between the flange (13) and the annular recess (22), after the seal (20) is inserted into the outlet (11), the seal (20) is secured by the flange (13). Thereafter, the user is able to use a needle (30) with an outer threading (31) formed to correspond to the inner threading (12) of the barrel (10) to screw into the outlet (11) so as to sandwich the seal (20) with the barrel (10).

After the needle (30) is threadingly inserted into the outlet (11), not only the position of the seal (20) is secured, but also the sealing effect of the seal (20) is accomplished due to the abutment of the needle (30) to the seal (20).

Therefore, it is noted that the nozzle assembly of the present invention is cost effective because the elimination of the connector. Furthermore, the assembly of the nozzle assembly is facilitated because of the inner threading (12) being adapted to correspond to the outer threading (31) of the needle (30).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A nozzle assembly for an air pump having a barrel with an outlet and a flange formed on an inner periphery of the barrel, a seal inserted into the outlet, wherein the improvements comprising:
an inner threading is formed on an inner periphery defining the outlet to adapt to correspond to an outer threading of a needle; and
an annular recess is defined in an outer periphery of the seal so that the seal is able to be secured by the flange after the seal is inserted into the outlet of the barrel.
